(19) United States
(12) Patent Application Publication
(10) Pub. No.: US 2023/0093194 A1
(43) Pub. Date: Mar. 23, 2023

(54) METHOD FOR MANUFACTURING HIGH SILICATE GLASS SUBSTRATE, HIGH SILICATE GLASS SUBSTRATE AND POROUS GLASS

(71) Applicant: AGC Inc., Tokyo (JP)

(72) Inventors: Tomonori OGAWA, Tokyo (JP); Yutaka KUROIWA, Tokyo (JP); Kosho AKATSUKA, Tokyo (JP); Hiroyuki HIJIYA, Tokyo (JP)

(73) Assignee: AGC Inc., Tokyo (JP)

(21) Appl. No.: 18/060,058

(22) Filed: Nov. 30, 2022

Related U.S. Application Data
(63) Continuation of application No. PCT/JP2021/020568, filed on May 28, 2021.

(30) Foreign Application Priority Data
Jun. 3, 2020 (JP) 2020-097128

(51) Int. Cl. C03C 11/00; C03B 19/06; C03B 32/00; C03C 15/00; C03C 23/00

(52) U.S. Cl. CPC C03C 11/005; C03B 19/06; C03B 32/00; C03C 15/00; C03C 23/0085

(57) ABSTRACT

A method for producing a high silicate glass substrate, includes: (1) obtaining a glass precursor containing, as represented by mol % based on oxides, 60% to 75% of SiO₂, 0% to 15% of Al₂O₃, 15% to 30% of B₂O₃, 0% to 3% of P₂O₅, and 1% to 10% in total of at least one selected from R₂O and R′O; (2) applying first heat treatment to the glass precursor to cause phase separation so as to obtain a phase-separated glass; (3) applying acid treatment to the phase-separated glass to make the phase-separated glass porous so as to obtain a porous glass; (4) drying the porous glass so that a rate of change in mass reaches 10% to 50%; and (5) applying second heat treatment to the porous glass to sinter the porous glass so as to obtain a high silicate glass substrate.

### CROSS-REFERENCE TO RELATED APPLICATIONS

This is a bypass continuation of International Patent Application No. PCT/JP2021/020568, filed on May 28, 2021, which claims priority to Japanese Patent Application No. 2020-097128, filed on Jun. 3, 2020. The contents of these applications are hereby incorporated by reference in their entireties.

### TECHNICAL FIELD

The present invention relates to a method for producing a high silicate glass substrate, a high silicate glass substrate, and a porous glass.

### BACKGROUND ART

Recently, radio transmission using a microwave band or a millimeter wave band attracts attention as a large-capacity transmission technology. That is accompanied by technologies such as computer peripheral equipment, radio communication equipment, ubiquitous communication equipment, wireless power feeding techniques, etc. High-frequency substrate materials superior in fundamental high-frequency properties are required as materials for use in such technologies.

However, expansion of a frequency band in service leads to a higher signal frequency, causing a problem of increase in dielectric loss in a dielectric layer of a high-frequency device. Therefore, materials low in dielectric loss are required as the high-frequency substrate materials. Among them, a glass containing plenty of silicate, such as a silica glass, is particularly low in dielectric loss and excellent as a high-frequency substrate material.

However, the silica glass increases cost on its production and processing. Therefore, a phase-separated borosilicate glass is produced, and other components than silicate are leached by acid so as to form a porous glass. The porous glass is sintered to be densified. When a high silicate glass obtained thus is used as a high-frequency substrate material, the cost can be suppressed.

Patent Literature 1 discloses a method for producing a high silicate glass having silicate as its main component. According to the method, an alkali borosilicate-based glass is phase-separated into an insoluble phase rich in SiO₂ and a soluble phase rich in B₂O₃ by heat treatment. After that, the soluble phase is leached by acid to thereby produce a porous glass having SiO₂ as its main component. Next, the porous glass is sintered to produce a high silicate glass.

### CITATION LIST

### Patent Literature

Patent Literature 1: U.S. Pat. No. 2,106,744

### SUMMARY OF INVENTION

### Technical Problem

To practically produce a high-frequency substrate material, a porous glass having a large area of 300 cm² or more has to be sintered. However, the porous glass is easily cracked during its production due to moisture or the like staying behind in the glass. It is difficult to sinter the glass without cracking compatibly with achievement of the large area.

An object of the invention is therefore to provide a method for producing a high silicate glass substrate suitable as a high-frequency substrate material and capable of being sintered with a large area and without cracking; a high silicate glass substrate; and a porous glass.

### Solution to Problem

The present inventor et al. found that when a porous glass having a specific composition is dried to have an amount of moisture within a specific range before the porous glass is sintered, the porous glass can be sintered with a large area without cracking so that a high silicate glass substrate can be obtained. Based on such findings, the present inventor et al. completed the invention. That is, the invention is described below.

The invention relates to a method for producing a high silicate glass substrate, which includes the following (1) to (5):

(1) obtaining a glass precursor containing, as represented by mol % based on oxides, 60% to 75% of SiO₂, 0% to 15% of Al₂O₃, 15% to 30% of B₂O₃, 0% to 3% of P₂O₅, and 1% to 10% in total of at least one selected from R₂O (R is at least one selected from Li, Na and K) and R′O (R′ is at least one selected from Mg, Ca, Sr and Ba);
(2) applying first heat treatment to the glass precursor to cause phase separation so as to obtain a phase-separated glass;
(3) applying acid treatment to the phase-separated glass to make the phase-separated glass porous so as to obtain a porous glass;
(4) drying the porous glass so that a rate of change in mass defined in the following Expression 1 reaches 10% to 50%:

rate of change in mass (%)=[(mass before drying−mass after drying)/mass before drying]×100 (Expression 1), and

(5) applying second heat treatment to the porous glass to sinter the porous glass so as to obtain a high silicate glass substrate.

The invention relates to a high silicate glass substrate containing, as represented by mol % based on oxides, 90% or more and less than 100% of SiO₂, 0% to 1% of Al₂O₃, and 0% to 10% of B₂O₃, having a base area of 300 cm² or more, and having an OH-group concentration of 1200 mass ppm or less.

The invention relates to a porous glass containing, as represented by mol % based on oxides, 90% or more and less than 100% of SiO₂, 0% to 1% of Al₂O₃, and 0% to 10% of B₂O₃, having a base area of 300 cm² or more, having a thickness of 3 mm or less, and having a median value of a pore size distribution at 150 nm or less.

### Advantageous Effects of Invention

In the method for producing a high silicate glass substrate according to the invention, a porous glass having a specific composition is dried to have an amount of moisture within a specific range before the porous glass is sintered. Thus, the porous glass can be sintered with a large area without cracking so that a high silicate glass substrate can be produced. The high silicate glass substrate according to the invention has a specific composition and has an OH-group concentration within a specific range. Thus, the high silicate glass substrate can have a large area suitably to a high-frequency substrate material. The porous glass according to the present invention has a composition, a thickness and a median value of a pore size distribution within specific ranges respectively. Thus, the porous glass can be sintered without cracking in spite of a large area, so as to produce a high-frequency substrate material.

### BRIEF DESCRIPTION OF DRAWINGS

FIG. 1 is a graph showing a change in dissipation factor in accordance with OH-group concentration of a glass.

FIG. 2 is a graph showing a result obtained by fluorescence measurement on the glass.

### DESCRIPTION OF EMBODIMENTS

Embodiments for carrying out the invention will be described below. However, the invention is not limited to the following embodiments. Various modifications and replacements may be added to the following embodiments without departing from the scope of the invention.

In the present description, any glass composition is represented by mol % based on oxides, and mol % may be mentioned as % simply. In addition, any word “to” designating a numerical value range means that the range includes the numerical values before and after the word as a lower limit value and an upper limit value.

### 1. Method for Producing High Silicate Glass Substrate

A method for producing a high silicate glass substrate according to the invention includes the following (1) to (5):

(1) obtaining a glass precursor containing, as represented by mol % based on oxides, 60% to 75% of SiO₂, 0% to 15% of Al₂O₃, 15% to 30% of B₂O₃, 0% to 3% of P₂O₅, and 1% to 10% in total of at least one selected from R₂O (R is at least one selected from Li, Na and K) and R′O (R′ is at least one selected from Mg, Ca, Sr and Ba);
(2) applying first heat treatment to the glass precursor to cause phase separation so as to obtain a phase-separated glass;
(3) applying acid treatment to the phase-separated glass to make the phase-separated glass porous so as to obtain a porous glass;
(4) drying the porous glass so that a rate of change in mass defined in the following Expression 1 reaches 10% to 50%:

rate of change in mass (%)=[(mass before drying−mass after drying)/mass before drying]×100 (Expression 1); and

(5) applying second heat treatment to the porous glass to sinter the porous glass so as to obtain a high silicate glass substrate.

The respective steps will be described below.

### <Step (1): Glass Precursor Production Step>

Step (1) is a step of producing a glass precursor. In Step (1), glass raw materials are prepared to obtain a glass composition containing, as represented by mol % based on oxides, 60% to 75% of SiO₂, 0% to 15% of Al₂O₃, 15% to 30% of B₂O₃, 0% to 3% of P₂O₅, and 1% to 10% in total of at least one selected from R₂O (R is at least one selected from Li, Na and K) and R′O (R′ is at least one selected from Mg, Ca, Sr and Ba).

SiO₂ is a main component which forms network of glass. In addition, it is a main component of the glass which has been made porous by acid treatment. It is a component which improves a dielectric property. The content of SiO₂ is 60% or higher, preferably 62% or higher, more preferably 63% or higher, and particularly preferably 65% or higher. When the content of SiO₂ is 60% or higher, weatherability can be improved. The content of SiO₂ is 75% or lower, preferably 72% or lower, more preferably 70% or lower, and particularly preferably 69% or lower. When the content of SiO₂ is 75% or lower, the composition can be set within a range suitable for phase separation.

Al₂O₃ is a component which improves the mechanical strength of the glass precursor and suppresses enlargement of its phase-separation structure. When Al₂O₃ is contained, the content of Al₂O₃ is preferably 0.5% or higher, more preferably 1% or higher, even more preferably 1.5% or higher, and particularly preferably 2% or higher. The content of Al₂O₃ which is 0.5% or higher is effective to prevent excessive enlargement of the phase-separation structure and to suppress contraction during sintering to thereby prevent the glass from easily cracking. The content of Al₂O₃ is 15% or lower, preferably 10% or lower, more preferably 8% or lower, even more preferably 6% or lower, and particularly preferably 4% or lower. When the content of Al₂O₃ is 15% or lower, the composition can be set within a range suitable for phase separation.

B₂O₃ is a component which promotes melting of the glass raw materials and reduces the viscosity of molten glass. In addition, it is a component which improves the mechanical properties or the weatherability of the glass precursor and promotes the phase separation. In addition, it is a component which reduces the dissipation factor of the glass that has been made porous. The content of B₂O₃ is 15% or higher, preferably 20% or higher, more preferably 22% or higher, and particularly preferably 24% or higher. When the content of B₂O₃ is 15% or higher, a phase-separated glass can be obtained. The content of B₂O₃ is 30% or lower, preferably 28% or lower, more preferably 26% or lower, and particularly preferably 25% or lower. When the content of B₂O₃ is 30% or lower, volatilization of the glass during its melting can be suppressed.

R₂O (R is at least one selected from Li, Na and K) is not an essential component. However, it is a component which is useful for promoting melting of the glass raw materials and adjusting thermal expansion, viscosity, etc., and which promotes the phase separation of the glass precursor. The total content of R₂O is preferably 1% or higher, more preferably 2% or higher, even more preferably 3% or higher, and particularly preferably 4% or higher. On the other hand, the content of R₂O is preferably 10% or lower, more preferably 9% or lower, even more preferably 8% or lower, and particularly preferably 7% or lower. When the content R₂O is 10% or lower, it is possible to secure the weatherability of the glass precursor.

R′O (R′ is at least one selected from Mg, Ca, Sr and Ba) is not an essential component. However, it is a component which improves the meltability of the glass without increasing the devitrification temperature of the glass, and which promotes the phase separation thereof. The total content of R′O is preferably 1% or higher, more preferably 2% or higher, even more preferably 3% or higher, and particularly preferably 4% or higher. When the content of R′O is 1% or higher, the phase separation can be promoted. On the contrary, excessive R′O hinders the phase separation. The total content of R′O is preferably 10% or lower, more preferably 9% or lower, even more preferably 8% or lower, and particularly preferably 7% or lower. When the content of R′O is 10% or lower, the phase separation can be achieved easily.

The total content of R₂O and R′O is 10% or lower, preferably 8% or lower, and more preferably 7% or lower. When the total content of R₂O and R′O is 10% or lower, components that may gel during acid treatment can be suppressed so that cracking during the acid treatment can be suppressed. In addition, alkali cleaning for removing gel in a cleaning step after the acid treatment can be omitted. On the other hand, the total content of R₂O and R′O is 1% or higher, preferably 2% or higher, more preferably 3% or higher, and particularly preferably 4% or higher.

P₂O₅ is a component which promotes the phase separation. When P₂O₅ is contained, the content thereof is preferably 0.1% or higher, more preferably 0.2% or higher, even more preferably 0.3% or higher, and particularly preferably 0.4% or higher. When the content of P₂O₅ is 0.1% or higher, a satisfactory effect of promoting the phase separation can be obtained. Thus, in a continuously forming process such as float forming, phase separation can be achieved on line so that additional heat treatment for the phase separation can be omitted. The content of P₂O₅ is 3% or lower, preferably 2% or lower, more preferably 1% or lower, and particularly preferably 0.9% or lower. When the content of P₂O₅ is 3% or lower, erosion of bricks or volatilization of the glass during its melting in a mass production furnace can be suppressed. In addition, excessive increase in coefficient of thermal expansion of the glass can be suppressed so that the glass can be prevented from cracking during the acid treatment.

Cl is a component which improves the refining property of the molten glass. The content of Cl is preferably 0.1% or higher, more preferably 0.15% or higher, even more preferably 0.2% or higher, and particularly preferably 0.25% or higher. When the content of Cl is 0.1% or higher, satisfactory refining property can be obtained. Thus, the number of bubbles in the glass precursor and the phase-separated glass can be suppressed. When the number of bubbles is reduced, it is possible to reduce the probability that cracking/cracks may occur starting at the bubbles during acid treatment or sintering in a mass production stage. The content of Cl is preferably 1% or lower, more preferably 0.7% or lower, even more preferably 0.5% or lower, and particularly preferably 0.3% or lower.

Various components other than the aforementioned components may be contained within a range where they do not spoil the effect of the present invention. For example, ZrO₂, TiO₂, La₂O₃, Ta₂O₅, TeO₂, Nb₂O₅, Gd₂O₃, Y₂O₃, Eu₂O₃, Sb₂O₃, SnO₂, Bi₂O₃, etc. may be contained within a range where each is preferably 5% or lower, more preferably 3% or lower, and particularly preferably 1% or lower.

Next, the prepared glass batch is melted at 1300 to 1600° C. for 4 to 12 hours. Next, the molten glass is shaped into a plate, and gradually cooled at 400 to 600° C. for 10 minutes to 10 hours so as to obtain a glass precursor. A method for obtaining the glass cursor is not particularly limited. In case of small-quantity production, for example, a crucible and a mold may be used. When mass production is carried out, continuous production may be performed, for example, in a refractory furnace.

When continuous production is performed in the refractory furnace, it is more preferable that molten glass at a temperature not lower than its softening point is discharged like a belt from the refractory furnace to form a glass ribbon, and supplied onto a surface of molten metal. The glass ribbon supplied onto the surface of the molten metal is transferred. The transferred glass ribbon is then cooled in an upstream area in the transferring direction so that the temperature of the glass ribbon is lower than the softening point all over the width thereof. Through such a step, the molten glass is shaped into a plate having a desired width and a desired thickness.

Viscosity of the glass melt to be supplied to the surface of the molten metal is, by log η, preferably 0.5 or higher, more preferably 1.0 or higher, even more preferably 1.5 or higher, and particularly preferably 2.0 or higher. On the other hand, the viscosity is preferably 5.5 or lower, more preferably 5.0 or lower, even more preferably 4.5 or lower, particularly preferably 4.0 or lower, and most preferably 3.5 or lower. The temperature of the molten metal is preferably not lower than the annealing point of the glass to be produced and not higher than the softening point of the glass. Thus, the glass can be shaped into a wide plate while being cooled rapidly. Particularly advantageously, therefore, not only is it possible to reduce a load in a later step of processing the plate, but it is also possible to suppress heterogeneity of the glass appearing during the shaping of the glass melt so that a more homogeneous glass plate can be obtained.

Preferably in the glass precursor according to the invention, a temperature T₂ where the glass viscosity reaches 10² dPa·s is 1700° C. or lower. When the temperature T₂ is 1700° C. or lower, the glass is excellent in meltability so that a load on production equipment can be reduced. For example, the life of equipment such as a furnace for melting the glass is prolonged to improve the productivity. In addition, defects arising from the furnace (such as spot defects or Zr defects) can be reduced. T₂ is more preferably 1680° C. or lower, and even more preferably 1670° C. or lower. T₂ is preferably 1630° C. or higher.

Preferably in the glass precursor according to the invention, a temperature T₄ where the glass viscosity reaches 10⁴ dPa·s is 1290° C. or lower. Thus, the glass is excellent in formability. In addition, for example, when the temperature of the glass which is being shaped is decreased, volatilized substances in an atmosphere around the glass can be reduced so that defects of the glass can be reduced. Since the glass can be shaped at a low temperature, the load on production equipment can be reduced. For example, the life of equipment such as a float bath for shaping the glass can be prolonged to improve the productivity. T₄ is more preferably 1280° C. or lower.

T₄ can be obtained according to a method specified in ASTM C 965-96. That is, a temperature where viscosity measured using a rotary viscometer reaches 10⁴ dPa·s is regarded as T₄. In examples which will be described later, NBS710 and NIST717a were used as reference specimens for device calibration.

Processing such as cutting, grinding or polishing may be applied to the obtained plate-like glass in order to form the plate-like glass into a desired size and a desired shape. The shape in a main surface thereof is not particularly limited, but it is preferably rectangular or circular.

The base area of the glass precursor obtained thus is preferably 300 to 5000 cm², more preferably 700 to 3600 cm², and even more preferably 900 to 2000 cm². The thickness of the glass precursor is preferably 0.5 to 3 mm, more preferably 0.7 to 2.5 mm, and even more preferably 1 to 2 mm. In the present description, the “base area” is an area of the main surface.

The aspect ratio of the glass precursor is preferably 500 to 36000, more preferably 1000 to 20000, and even more preferably 5000 to 10000. When the aspect ratio is too small, a large difference in velocity to remove a phase rich in boron oxide appears between the surface of the glass precursor and the inside thereof in the step (3) of making the glass porous, which will be described later. Due to the large difference, stress occurs so easily that the porous glass is easily cracked. On the contrary, when the aspect ratio is too large, the glass precursor cannot be handled easily. In the present description, the “aspect ratio” designates a ratio of area in the main surface (cm²) to thickness (cm).

The number of bubbles in the glass precursor is preferably 0.1 piece/cm² in the main surface in order to suppress the probability that cracking/cracks may occur starting at the bubbles during acid treatment or sintering in a mass production stage. The number of bubbles in the glass precursor can be measured visually or with an optical microscope by use of a high-intensity light source or the like.

### <Step (2): Phase Separation Step>

Step (2) is a step of applying first heat treatment to the glass precursor obtain in Step (1) to thereby phase-separate the glass precursor into an insoluble phase (silicate phase) having SiO₂ as its main component and a soluble phase (boric phase) having B₂O₃ as its main component, so as to obtain a phase-separated glass. Whether the glass has been phase-separated can be determined by SEM. When the glass has been phase-separated, separation into two or more phases can be observed by observation with the SEM.

Examples of the phase-separated glass includes a binodal phase-separated glass in a binodal state and a spinodal phase-separated glass in a spinodal state. The binodal state is a state of phase separation caused by a nucleus forming-growing mechanism. The binodal state is typically spherical. On the other hand, the spinodal state is a state where separated phases are intertwined with each other continuously in three dimensions with some degree of regularity. A spinodal phase-separated glass which will be described later is particularly preferable as the phase-separated glass in the invention.

Heat treatment temperature is higher than the glass transition point preferably by 50° C. or more, and more preferably by 100° C. or more. In order to suppress deformation of the glass, the heat treatment temperature is equal to or not higher than a temperature which is preferably 400° C. higher than the glass transition point, and more preferably 300° C. higher than the glass transition point.

Specifically the heat treatment temperature is, for example, preferably 400° C. or higher and 1000° C. or lower, more preferably 500° C. or higher and 900° C. or lower, and even more preferably 550° C. or higher and 800° C. or lower. When the heat treatment temperature is too high, the glass precursor is softened so that it is difficult to obtain a desired shape. On the contrary, when the heat treatment temperature is too low, phase separation cannot be achieved easily in the glass precursor.

Heat treatment time is preferably 10 minutes or more, more preferably 1 hour or more, and even more preferably 3 hours or more. When the heat treatment time is too short, phase separation cannot be achieved easily in the glass precursor. The upper limit of the heat treatment time is not particularly specified. From the point of view of mass productivity, the heat treatment time is preferably 36 hours or less, more preferably 24 hours or less, and even more preferably 12 hours or less.

Examples of methods for achieving the phase separation in the glass include a method for applying heat treatment to the glass after shaping the glass, and a method for keeping the glass not lower than the phase separation temperature before shaping the glass. In the method for keeping the glass not lower than the phase separation temperature before shaping the glass, for example, the glass which has been once kept not lower than the phase separation start temperature is kept not higher than the phase separation start temperature in order to achieve phase separation. A specific example of such a method includes a method in which the glass once kept not lower than the phase separation start temperature is kept not higher than the phase separation start temperature for phase separation on line during continuous production using a refractory furnace by a float process or the like.

### <Step (3): Acid Treatment Step>

Step (3) is a step in which the phase-separated glass obtained in Step (2) is immersed in acid for acid treatment so that the soluble phase (boric phase) having B₂O₃ as its main component is removed to make the glass porous to thereby obtain a porous glass. Examples of the acid include hydrochloric acid and sulfuric acid. Each of those acids may be used alone, or a mixture of them may be used. Concentration of the acid is preferably 0.1 to 5 mol/L, more preferably 0.5 to 4 mol/L, and even more preferably 1 to 3 mol/L. Temperature of the acid (immersing temperature) is preferably 40° C. or higher, more preferably 50° C. or higher, even more preferably 60° C. or higher, and particularly preferably 80° C. or higher. When the immersing temperature is low, the glass may be easily cracked due to abnormal expansion or contraction occurring in an early stage. This is because the low immersing temperature increases the elution ratio of Na₂O to B₂O so that swelling of the glass caused by replacement between Na⁺ and H₃O⁺ is larger than contraction of the Si network caused by elution of B. When the immersing temperature is set at 40° C. or higher, such abnormal expansion or contraction in an early stage can be suppressed to prevent the glass from easily cracking. The upper limit of the immersing temperature is not particularly limited. Practically the immersing temperature is preferably 100° C. or lower.

Immersing time in the acid is preferably one hour or more, more preferably 5 hours or more, even more preferably 10 hours or more, and particularly preferably 20 hours or more. When the immersing time is too short, a porous glass cannot be obtained easily. The upper limit of the immersing time is not particularly limited. Practically the immersing time is 50 hours or less.

In the porous glass obtained by the acid treatment applied to the phase-separated glass to thereby make the glass porous, the median value of a pore size distribution is preferably 150 nm or less, more preferably 100 nm or less, and even more preferably 80 nm or less. When the median value of the pore size distribution is 150 nm or less, cracking during sintering can be suppressed. The median value of the pore size distribution is preferably 10 nm or more, more preferably 20 nm or more, and even more preferably 30 nm or more. In the phase separation where the median value of the pore size distribution is within the aforementioned range, acid can easily enter pores when in the leaching. Thus, the acid treatment time for making the glass porous can be suppressed. The pore size distribution can be obtained by a BHJ method from a nitrogen adsorption isotherm based on a gas adsorption method.

### <Step (4): Drying Step>

Step (4) is a step of drying the porous glass obtained in Step (3). When the porous glass is dried in the drying step, moisture adhering to the porous glass is evaporated as vapor and removed from the porous glass. A cleaning step in which the glass is immersed in water (such as purified water) or the like may be performed between Step (3) and Step (4). In order to prevent the porous glass from cracking due to a sudden temperature change, the difference between the temperature of the water or the like to be used in the cleaning step and the temperature of the acid treatment is set preferably within ±20° C., more preferably within ±10° C., and even more preferably within ±5° C. Further, ultrasonic waves may be used for cleaning in order to remove residual components inside the porous glass.

In Step (4), a rate of change in mass defined in the following Expression (1) is 10% or more, preferably 11% or more, more preferably 12% or more, and even more preferably 13% or more. The porous glass may be easily cracked during its production due to moisture or the like left behind in the glass. When the glass is dried to set the rate of change in mass at 10% or more in Step (4) and then sintered in Step (5), the glass can be shaped into a plate and sintered without cracking. The upper limit of the rate of change in mass is not particularly limited. Typically, the rate of change in mass is preferably 20% or less, and more preferably 15% or less.

rate of change in mass (%)=[(mass before drying−mass after drying)/mass before drying]×100 (Expression 1)

According to a method for measuring the rate of change in mass, the porous glass obtained in Step (3) is left in a normal atmosphere of atmospheric pressure overnight as it is (this state is regarded as before drying). The mass of the glass before drying is measured. Drying is then performed, and the mass of the glass after drying is measured.

A drying method is not particularly limited. Examples of the drying method include a method for drying in the atmosphere of atmospheric pressure preferably at 20° C. or higher and 100° C. or lower, more preferably at 30° C. or higher and 90° C. or lower, and even more preferably at 40° C. or higher and 80° C. or lower, and preferably for 1 hour or more and 36 hours or less, more preferably for 2 hour or more and 24 hours or less, and even more preferably for 3 hour or more and 12 hours or less; and a method for drying in a vacuum preferably for 1 hour or more and 36 hours or less, more preferably for 2 hour or more and 24 hours or less, and even more preferably for 3 hour or more and 12 hours or less.

### <Step (5): Sintering Step>

Step (5) is a step in which second heat treatment is applied to the porous glass dried in Step (4) to thereby sinter the glass so as to obtain a high silicate glass substrate.

In the second heat treatment, it is preferable to increase the temperature to a control temperature at a temperature rising rate of preferably 100° C./hr or lower, more preferably 70° C./hr or lower, and even more preferably 50° C./hr or lower. When the temperature rising rate is set at 100° C./hr or lower, cracking in the glass can be suppressed. The lower limit of the temperature rising rate is not particularly limited. Typically it is 10° C./hr or higher.

In order to sinter the glass, the control temperature in the second heat treatment is preferably 900° C. or higher, more preferably 1000° C. or higher, and even more preferably 1100° C. or higher. In order to suppress fusion with a setter, the control temperature is preferably 1250° C. or lower, more preferably 1200° C. or lower, and even more preferably 1150° C. or lower. In order to sinter the glass, the glass is kept at the control temperature preferably for 3 hours or more and 25 hours or less, more preferably for 4 hours or more and 15 hours or less, and even more preferably for 5 hours or more and 10 hours or less.

The second heat treatment is preferably performed under an environment having a dew point temperature preferably at 60° C. or lower, more preferably at 56° C. or lower, even more preferably at 39° C. or lower, even more preferably at 22° C. or lower, even more preferably at 20° C. or lower, particularly preferably at 10° C. or lower, and most preferably at 0° C. or lower. When the dew point temperature is too high during the second heat treatment, moisture tends to be absorbed in the porous glass. When the dew point temperature is set at 60° C. or lower, moisture can be prevented from being absorbed in the porous glass, so that the OH-group concentration in the obtained high silicate glass substrate can be suppressed to improve the dissipation factor. The lower limit value of the dew point temperature is not particularly limited. Practically the dew point temperature is −40° C. or higher.

The second heat treatment may be performed under atmospheric pressure. In order to control the concentration of OH groups, it is preferable to perform the second heat treatment under an atmosphere of nitrogen, dried air, hydrogen, or a mixture of them.

Specifically in Step (5), the porous glass is, for example, held by a setter so that the porous glass can be sintered by heating while being prevented from warping. Thus, the porous glass can be flattened. The material of the setter is not particularly limited. Examples of the material of the setter include ceramic materials such as alumina, cordierite, and mullite. Surface roughness Ra of the setter is preferably 1 μm or less, more preferably 0.5 μm or less, and even more preferably 0.1 μm or less. When Ra is set at 1 μm or less, the surface roughness of the sintered glass can be reduced, and a load in subsequent processing steps can be reduced. On the other hand, Ra is typically 1 nm or more. In addition, as for the weight of the setter, warpage can be effectively suppressed when a load per unit area is preferably 3 g/cm². In addition, flatness of the setter defined by JIS 0621-1984 is preferably 1 mm or less, more preferably 0.5 mm or less, and even more preferably 0.1 mm or less. When the flatness is set at 1 mm or less, the warpage of the sintered glass substrate can be reduced, and a load in subsequent processing steps can be reduced. On the other hand, the flatness is typically 0.001 mm or more.

The base area of the setter is preferably one or more times and 1.5 or less times as large as the base area of the porous glass, more preferably 1.05 or more times and 1.3 or less times, and even more preferably 1.1 or more times and 1.2 or less times.

The content of SiO₂ after sintering is 90% or higher, preferably 92% or higher, even more preferably 94% or higher, and particularly preferably 96% or higher. When the content of SiO₂ after sintering is 90% or higher, weatherability can be improved. The content of SiO₂ after sintering is lower than 100%, preferably 99% or lower, more preferably 98% or lower, and particularly preferably 97% or lower. When the content of SiO₂ after sintering is lower than 100%, reduction in mechanical strength can be suppressed.

Al₂O₃ is a component which improves mechanical strength. It is also a component which controls expansion and contraction of the glass during the acid treatment for making the glass precursor porous. Al₂O₃ may be contained. When Al₂O₃ is contained after sintering, the content of Al₂O₃ is preferably 0.05% or higher, and more preferably 0.1% or higher. When the content of Al₂O₃ is 0.05% or higher, the mechanical strength can be improved. The content of Al₂O₃ after sintering is 1% or lower, preferably 0.5% or lower, and more preferably 0.3% or lower. When the content of Al₂O₃ is 1% or lower, devitrification during sintering can be suppressed.

When B₂O₃ is contained after sintering, the content of B₂O₃ after sintering is preferably 0.5% or higher, more preferably 1% or higher, even more preferably 2% or higher, and particularly preferably 3% or higher. When the content of B₂O₃ after sintering is 0.5% or higher, viscosity can be reduced and sintering temperature can be reduced. The content of B₂O₃ after sintering is 10% or lower, preferably 8% or lower, more preferably 6% or lower, and particularly preferably 4% or lower. When the content of B₂O₃ is 10% or lower, reduction in weatherability can be suppressed.

Various components other than the aforementioned components may be contained within a range where they do not spoil the effect of the present invention. For example, R₂O (R is at least one selected from Li, Na and K), R′O (R′ is at least one selected from Mg, Ca, Sr and Ba), ZrO₂, TiO₂, La₂O₃, Ta₂O₅, TeO₂, Nb₂O₅, Gd₂O₃, Y₂O₃, Eu₂O₃, Sb₂O₃, SnO₂, P₂O₅, Bi₂O₃, etc. may be contained within a range where each is preferably 3% or lower, more preferably 2% or lower, particularly preferably 1% or lower, even more preferably 0.5% or lower, and further even more preferably 0.1% or lower. As long as R₂O and R′O contained in the high silicate glass are within the aforementioned range, the dissipation factor is not deteriorated. In addition, when R₂O and R′O contained in the glass precursor for manufacturing are within a range where high silicate glass can be produced without cracking in spite of a large area, R₂O and R′O contained in the high silicate glass are within the aforementioned range.

A high silicate glass substrate can be formed by the aforementioned steps.

### <Other Steps>

When the high silicate glass substrate according to the invention is used as a high-frequency substrate material, holes may be made in the high silicate glass. A method for forming the holes is not particularly limited. For example, a method for irradiating the high silicate glass substrate with a laser beam is preferred in order to accurately form small holes each having a diameter of 200 μm or less. The high silicate glass substrate according to the invention is excellent in processability by irradiation with a laser beam. The wavelength of the laser beam is not particularly limited. For example, wavelengths of 10.6 μm or less, 3000 nm or less, 2050 nm or less, 1090 nm or less, 540 nm or less, and 400 nm or less can be used. Particularly to form small holes each having a diameter of 50 μm or less, the following two methods are preferred.

### (Processing by UV Laser)

Holes are formed inside the high silicate glass substrate by irradiation with a UV laser beam having a wavelength of 400 nm or less. More preferably, the UV laser beam is oscillated as pulses, and an absorption layer is placed for the laser irradiation in a surface of the high silicate glass substrate. After the laser irradiation, the high silicate glass substrate may be etched with a fluorine-containing solution so as to expand the holes. According to such a method, holes can be formed with high verticality and with narrow portions being suppressed.

### (Processing by Formation of Modified Portions)

Modified portions are formed inside the high silicate glass substrate by irradiation with a laser beam having, a wavelength of 400 to 540 nm, for example, about 532 nm. Subsequently, the high silicate glass substrate is etched with a fluorine-containing solution to selectively remove the modified portions to thereby form holes. According to such a method, the laser beam can be oscillated as pulses, and the modified portions can be formed only by irradiation with the pulses at one shot. Thus, the holes can be formed at a high speed and with excellent productivity.

### 2. High Silicate Glass Substrate

The high silicate glass substrate according to the invention contains, as represented by mol % based on oxides, 90% or more and less than 100% of SiO₂, 0% to 1% of Al₂O₃, and 0% to 10% of B₂O₃. The reason why the content of each component is specified within such a range will be described.

SiO₂ is a main component which forms a network of the glass. It is a component which improves the weatherability and reduces the dissipation factor. The content of SiO₂ is 90% or higher, preferably 92% or higher, more preferably 94% or higher, and particularly preferably 96% or higher. When the content of SiO₂ is 90% or higher, the weatherability can be improved. The content of SiO₂ is lower than 100%, preferably 99% or lower, more preferably 98% or lower, and particularly preferably 97% or lower. When the content of SiO₂ is lower than 100%, reduction in mechanical strength can be suppressed.

Al₂O₃ is a component which improves the mechanical strength. In addition, it is a component which controls expansion and contraction of the glass during the acid treatment for making the glass precursor porous. When Al₂O₃ is contained, the content of Al₂O₃ is preferably 0.05% or higher, and more preferably 0.1% or higher. When the content of Al₂O₃ is 0.05% or higher, the mechanical strength can be improved. The content of Al₂O₃ is 1% or lower, preferably 0.5% or lower, and more preferably 0.3% or lower. When the content of Al₂O₃ is 1% or lower, devitrification during sintering can be suppressed.

B₂O₃ is a component which reduces the viscosity and reduces the sintering temperature. In addition, it is a component which reduces the dissipation factor. When B₂O₃ is contained, the content of B₂O₃ is preferably 0.5% or higher, more preferably 1% or higher, even more preferably 2% or higher, and particularly preferably 3% or higher. When the content of B₂O₃ is 0.5% or higher, there is an effect of reducing the viscosity. The content of B₂O₃ is 10% or lower, preferably 8% or lower, more preferably 6% or lower, and particularly preferably 4% or lower. When the content of B₂O₃ is 10% or lower, reduction in weatherability can be suppressed.

Various components other than the aforementioned components may be contained within a range where they do not spoil the effect of the invention. For example, R₂O (R is at least one selected from Li, Na and K), R′O (R′ is at least one selected from Mg, Ca, Sr and Ba), ZrO₂, TiO₂, La₂O₃, Ta₂O₅, TeO₂, Nb₂O₅, Gd₂O₃, Y₂O₃, Eu₂O₃, Sb₂O₃, SnO₂, P₂O₅, Bi₂O₃, etc. may be contained within a range where each is preferably 3% or lower, more preferably 2% or lower, particularly preferably 1% or lower, even more preferably 0.5% or lower, and further even more preferably 0.1% or lower. As long as R₂O and R′O contained in the high silicate glass are within the aforementioned range, the dissipation factor is not deteriorated. In addition, when R₂O and R′O contained in the glass precursor for manufacturing are within a range where high silicate glass can be produced without cracking in spite of a large area, R₂O and R′O contained in the high silicate glass are within the aforementioned range.

The high silicate glass substrate according to the invention has a base area of 300 cm² or more, preferably 600 cm² or more, more preferably 900 cm² or more, and even more preferably 1200 cm² or more. When the base area is 300 cm² or more, the high silicate glass substrate is suitable for a high-frequency substrate material. In order secure strength, the base area is preferably 5000 cm² or less.

The high silicate glass substrate according to the invention has an OH-group concentration of 1200 mass ppm or less, preferably 1000 mass ppm or less, and more preferably 800 mass ppm or less. When the OH-group concentration is 1200 mass ppm or less, the dissipation factor (hereinafter also abbreviated to DO can be reduced. The lower limit of the OH-group concentration is not particularly limited. Typically the OH-group concentration is 10 mass ppm or more.

The OH-group concentration is measured by an infrared spectrophotometer according to a literature [Cer. Bull., 55(5), 524, 1976]. This measurement has a detection limit at 1 mass ppm. The OH-group concentration can be adjusted by adjustment of an atmosphere, a dew point temperature, etc. in the sintering step which will be described later. Specific examples of methods for adjusting the OH-group concentration include preparing nitrogen or dried air as the atmosphere in the sintering step, and setting the dew point temperature at 60° C. or lower.

In the high silicate glass substrate according to the invention, the dissipation factor at 60 GHz is preferably 0.001 or less, more preferably 0.0009 or less, even more preferably 0.0008 or less, and particularly preferably 0.0007 or less. The lower limit of the dissipation factor at 60 GHz is not particularly limited. Typically it is 0.0001 or more.

A method according to a literature [Y. Kato and M. Horibe, “Permittivity measurements and associated uncertainties up to 110 GHz in circular-disk resonator method” Proceedings of the 46th European Microwave Conference (2016) 4-6 Oct. 2016.] may be used as a method for measuring the dissipation factor.

The thickness of the high silicate glass substrate according to the invention is preferably 0.05 to 2 mm, more preferably 0.1 to 1 mm, and even more preferably 0.3 to 0.8 mm. When the thickness is set within the aforementioned range, the high silicate glass substrate can be used suitably as a high-frequency substrate material.

The high silicate glass substrate according to the invention is suitable as a high-frequency substrate material, an aerospace material, or a heat-resistant material. Further, the high silicate glass substrate according to the invention is also suitable as a substrate material for a DNA chip, or a cell culture container due to its low fluorescence.

When the high silicate glass substrate according to the invention is used as a high-frequency substrate material, a substrate material for a DNA chip, or a cell culture container, holes may be formed in the high silicate glass. The holes are used as electrodes. The high silicate glass substrate according to the invention is excellent in processability so that minute holes can be formed therein easily by a laser or the like. The holes may be through holes, or non-through holes. The opening diameter of each hole is, for example, 200 μm or less, 100 μm or less, or 50 μm or less.

### 3. Porous Glass

The porous glass according to the invention contains, as represented by mol % based on oxides, 90% or more and less than 100% of SiO₂, 0% to 1% of Al₂O₃, and 0% to 10% of B₂O₃, has a base area of 300 cm² or more, has a thickness of 3 mm or less, and has a median value of a pore size distribution at 150 nm or less. The reasons why the composition, the base area, the thickness and the median value of the pore size distribution are set within the aforementioned ranges respectively are similar to the aforementioned ones in <1. Method for Producing High Silicate Glass Substrate> and <2. High Silicate Glass Substrate>.

When the porous glass according to the invention is sintered, a high-frequency substrate material can be produced without cracking in spite of a large area. Examples of applications of the porous glass according to the invention include a window material which has both of transparency and air permeability belonging to the properties of the porous glass, and a matrix in which pores are impregnated with various functional materials so as to carry the materials. A production method including the aforementioned steps (1) to (3) in <1. Method for Producing High Silicate Glass Substrate>, which can obtain a porous body with a large base area, is suitable as a method for producing the porous glass according to the invention.

### EXAMPLES

The invention will be described along its examples, but the invention is not limited to the examples.

### [Methods for Measuring Physical Properties]

Respective methods for measuring physical properties will be described below.

### (Dissipation Factor)

The dissipation factor was measured by the method according to the literature [Y. Kato and M. Horibe, “Permittivity measurements and associated uncertainties up to 110 GHz in circular-disk resonator method” Proceedings of the 46th European Microwave Conference (2016) 4-6 Oct. 2016.].

### (OH-Group Concentration)

The OH-group concentration was measured by an infrared spectrophotometer according to the literature [(Cer. Bull., 55(5), 524, 1976]. This measurement had a detection limit at 1 mass ppm.

### Experiment Example 1

### <Production of Porous High Silicate Glass>

### <<Step (1): Glass Precursor Production Step>>

Raw materials such as silica sand were mixed to obtain each of glasses having compositions shown in Table 1A and Table 1B (as represented by mol % based on oxides), so as to prepare a batch of 500 g. The raw materials were put into a platinum crucible, and heated in an electric furnace at a temperature of 1600° C. for 3 hours to be thereby melted into molten glass. During the melting of the glass, a platinum stirrer was inserted into the platinum crucible to stir the glass to thereby homogenize the glass. The molten glass was poured onto a carbon plate to be thereby shaped into a plate. The plate-like glass was then put into the electric furnace at a temperature of about Tg+50° C., and held therein for 1 hour. After that, the temperature of the electric furnace was dropped down to Tg−100° C. at a cooling rate of 1° C./min. The glass was then naturally cooled to reach a room temperature.

### <<Step (2): Phase Separation Step>>

The glass obtained in Step (1) was held at 600° C. for 27 hours. The temperature of the electric furnace was then dropped down to Tg−100° C. at a cooling rate of 1° C./min. The glass was then naturally cooled to reach the room temperature to be thereby phase-separated. After that, the glass was cut and polished to prepare a glass substrate having a thickness of 1.0 mm and a shape of 50×50 mm and having an arithmetic average roughness Ra of 1.0 nm in its main surface.

### <<Step (3): Acid Treatment Step>>

The glass phase-separated in Step (2) and 10 L of a 2 mol/L HCl solution were set in a closed container, and acid treatment was performed thereon at 40, 60 or 90° C. for 20 hours. Thus, cracking during the acid treatment was inspected. The results are shown in Table 1A and Table 1B. In Table 1A and Table 1B, Ex. 1, 2, 4, 5, 10 and 11 are inventive examples, and Ex. 3, 6 to 9, and 12 to 18 are comparative examples.

The “cracking during acid treatment” was evaluated under the following criteria in Table 1A and Table 1B.

N: no visual cracking/cracks
Y: visual cracking/cracks

### <<Step (4): Drying Step>>

The glass obtained in Step (3) was immersed in purified water at 80° C., and washed for 20 minutes while ultrasonic waves of 28 kHz were applied thereto. The glass was then extracted and left at the room temperature for 12 hours. After that, the glass was dried for 3 hours in a vacuum furnace under reduced pressure of 20 kPa so as to set a rate of change in mass at 10 to 50%.

### <<Step (5): Sintering Step>>

The glass dried in Step (4) was held with an alumina setter of 60 mm×60 mm×1 mm, and sintered under the atmospheric pressure on the following conditions. Results of inspection about cracking during the sintering are shown in Table 1A and Table 1B. Temperature rising rate and time: 100° C./hr and 11 hours, control temperature and time: 1100° C. and 10 hours, and temperature dropping rate and time: 100° C./hr

The “cracking during sintering” was evaluated under the following criteria (n=3) in Table 1A and Table 1B.

N: no visual cracking/cracks
Y: visual cracking/cracks

TABLE 1A

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| composition | SiO₂ | 66.1 | 65.6 | 61.1 | 66.8 | 67.1 | 53.0 | 53.0 | 60.0 | 60.0 |
| (mol %) | Al₂O₃ | 2.2 | 2.2 | 2.2 | 1.6 | 1.2 | 12.0 | 12.0 | 3.0 | 1.0 |
| | B₂O₃ | 24.9 | 24.9 | 24.9 | 24.9 | 24.9 | 25.0 | 25.0 | 25.0 | 25.0 |
| | Li₂O | 0.0 | 0.0 | 0.0 | 0.0 | 0.0 | 0.0 | 0.0 | 0.0 | 0.0 |
| | Na₂O | 6.9 | 6.8 | 6.8 | 6.8 | 6.8 | 5.0 | 10.0 | 12.0 | 14.0 |
| | MgO | 0.0 | 0.0 | 0.0 | 0.0 | 0.0 | 5.0 | 0.0 | 0.0 | 0.0 |
| | CaO | 0.0 | 0.0 | 0.0 | 0.0 | 0.0 | 0.0 | 0.0 | 0.0 | 0.0 |
| | SrO | 0.0 | 0.0 | 0.0 | 0.0 | 0.0 | 0.0 | 0.0 | 0.0 | 0.0 |
| | P₂O₅ | 0.0 | 0.5 | 5.0 | 0.0 | 0.0 | 0.0 | 0.0 | 0.0 | 0.0 |
| phase separation | temperature (° C.) | 600.0 | 600.0 | 600.0 | 600.0 | 600.0 | 600.0 | 600.0 | 600.0 | 600.0 |
| treatment | hour | 27.0 | 27.0 | 27.0 | 27.0 | 27.0 | 27.0 | 27.0 | 27.0 | 27.0 |
| phase separation | structure | spinodal | spinodal | binodal | spinodal | spinodal | — | — | — | — |
| structure | size (nm) | 20-40 | 40-80 | — | — | — | — | — | — | — |
| high temperature | T2 (° C.) | 1502 | 1602 | — | — | — | — | — | — | — |
| viscosity | T3 (° C.) | 1208 | 1274 | — | — | — | — | — | — | — |
| | T4 (° C.) | 1018 | 1058 | — | — | — | — | — | — | — |
| cracking during | 90° C. acid treatment | N | N | Y | N | N | Y | Y | Y | Y |
| acid treatment | 60° C. acid treatment | N | Y | — | — | — | Y | Y | Y | Y |
| | 40° C. acid treatment | N | — | — | — | — | — | — | — | — |

| | | | | | | | | | |
|---|---|---|---|---|---|---|---|---|---|
| number of cracks during sintering (n = 3) | 0 | 0 | — | 0 | 0 | — | — | — | — |

TABLE 1B

| | | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|---|
| composition | SiO₂ | 68.0 | 62.0 | 57.0 | 53.0 | 45.0 | 53.0 | 53.0 | 60.0 | 57.5 |
| (mol %) | Al₂O₃ | 2.0 | 8.0 | 8.0 | 12.0 | 15.0 | 12.0 | 12.0 | 5.0 | 8.0 |
| | B₂O₃ | 20.0 | 20.0 | 25.0 | 25.0 | 30.0 | 5.0 | 10.0 | 20.0 | 25.0 |
| | Li₂O | 7.5 | 0.0 | 0.0 | 0.0 | 0.0 | 0.0 | 0.0 | 0.0 | 0.0 |
| | Na₂O | 0.0 | 0.0 | 0.0 | 0.0 | 0.0 | 0.0 | 0.0 | 0.0 | 0.0 |
| | MgO | 0.0 | 5.0 | 5.0 | 10.0 | 10.0 | 30.0 | 25.0 | 10.0 | 5.0 |
| | CaO | 2.5 | 5.0 | 5.0 | 0.0 | 0.0 | 0.0 | 0.0 | 5.0 | 4.5 |
| | SrO | 0.0 | 0.0 | 0.0 | 0.0 | 0.0 | 0.0 | 0.0 | 0.0 | 0.0 |
| | P₂O₅ | 0.0 | 0.0 | 0.0 | 0.0 | 0.0 | 0.0 | 0.0 | 0.0 | 0.0 |
| phase separation | temperature (° C.) | 600.0 | 600.0 | 600.0 | 600.0 | 600.0 | 600.0 | 600.0 | 600.0 | 600.0 |
| treatment | hour | 27.0 | 27.0 | 27.0 | 27.0 | 27.0 | 27.0 | 27.0 | 27.0 | 27.0 |
| phase separation | structure | spinodal | spinodal | spinodal | spinodal | spinodal | spinodal | spinodal | spinodal | spinodal |
| structure | size (nm) | — | 10-30 | 10-30 | 50-100 | — | — | — | 200-500 | — |
| high temperature | T2 (° C.) | 1559 | 1639 | 1540 | 1453 | — | — | — | 1734 | 1713 |
| viscosity | T3 (° C.) | 1242 | 1392 | 1314 | 1263 | — | — | — | 1541 | 1538 |
| | T4 (° C.) | 1032 | 1227 | 1160 | 1130 | — | — | — | 1399 | 1394 |
| cracking during | 90° C. acid treatment | N | N | N | N | Y | Y | Y | N | N |
| acid treatment | 60° C. acid treatment | N | — | — | — | — | — | — | — | Y |
| | 40° C. acid treatment | Y | — | — | — | — | — | — | — | — |

| | | | | | | | | | |
|---|---|---|---|---|---|---|---|---|---|
| number of cracks during sintering (n = 3) | 0 | 0 | 3 | 3 | — | — | — | 3 | 3 |

As shown in Table 1A and Table 1B, in Ex. 1, 2, 4, 5, 10 and 11 which were inventive examples, precursors were high silicate glass ones having compositions within the ranges defined according to the invention, and cracking/cracks did not occur during acid treatment and sintering. On the other hand, in Ex. 3, 6 to 9, and 12 to 18 which were comparative examples, cracking/cracks occurred during acid treatment and sintering.

### Experiment Example 2

### <Test of Refining of Glass Precursor>

Raw materials such as silica sand were mixed to obtain each of glasses having the same composition as that in Ex. 1 as shown as represented by mol % based on oxides in Table 2, so as to prepare a batch of 500 g. The raw materials were put into a platinum crucible of φ100 mm, and heated in an electric furnace at a temperature of 1600° C. for 3 hours to be thereby melted into molten glass. The molten glass together with the platinum crucible was put into the electric furnace at a temperature of about Tg+50° C., and held therein for 1 hour. After that, the temperature of the electric furnace was dropped down to Tg−100° C. at a cooling rate of 1° C./min. The glass was then naturally cooled to reach the room temperature. After that, a glass block obtained by use of a core drill was cored with φ50 mm out of the glass from the crucible. The glass block was ground and polished to be about 10 mm thick so as to expose optical mirror surfaces which were parallel with each other in a cutting section direction, and the number of bubbles were evaluated by an optical microscope. Results of the evaluation are shown in Table 2. Ex. 19 to 22 are inventive examples in Table 2.

“Refining property” in Table 2 shows the number of bubbles per 1 cm².

TABLE 2

| | | Ex. 19 | Ex. 20 | Ex. 21 | Ex. 22 |
|---|---|---|---|---|---|
| composition | SiO₂ | 66.1 | 66.1 | 66.1 | 66.1 |
| (mol %) | Al₂O₃ | 2.2 | 2.2 | 2.2 | 2.2 |
| | B₂O₃ | 24.9 | 24.9 | 24.9 | 24.9 |
| | Li₂O | 0.0 | 0.0 | 0.0 | 0.0 |
| | Na₂O | 6.9 | 6.9 | 6.9 | 6.9 |
| | MgO | 0.0 | 0.0 | 0.0 | 0.0 |
| | CaO | 0.0 | 0.0 | 0.0 | 0.0 |
| | SrO | 0.0 | 0.0 | 0.0 | 0.0 |
| | P₂O₅ | 0.0 | 0.0 | 0.0 | 0.0 |
| | Cl | 0.05 | 0.10 | 0.15 | 0.20 |

| | | | | |
|---|---|---|---|---|
| Refining property | >10 | <0.1 | <0.1 | <0.1 |

As shown in Table 2, when the composition was arranged to have a Cl content of 0.1% or higher in the step of producing a high silicate glass precursor in each of Ex. 20 to 22 where the content of Cl was 0.1% or higher, occurrence of bubbles was suppressed to have excellent refining property, as compared with Ex. 19 where the content of Cl was lower than 0.1%.

### Experiment Example 3

### <Production of Large-Size High Silicate Glass>

### <<Step (1): Glass Precursor Production Step>>

Respective reagents were weighed and mixed to have a glass composition as represented by mol % based on oxides in Ex. 20 so as to obtain a prepared batch of 13 kg. Next, the raw materials were put in a platinum crucible at 1550° C. for 4 hours, then stirred by a platinum stirrer for 1 hour, and then left at rest for 2 hours. After that, the temperature was dropped to 1250° C., and cast with a carbon mold to obtain a glass (glass precursor) block of 400 mm×400 mm×30 mm.

### <<Step (2): Phase Separation Step>>

The glass obtained in Step (1) was polished, and heat treatment was then performed thereon under conditions shown in Table 1 so as to achieve phase separation. After that, the block was sliced and ground to obtain a glass substrate of 375 mm×375 mm×1.2 mm.

### <<Step (3): Acid Treatment Step>>

The glass phase-separated in Step (2) and 10 L of a 2 mol/L HCl solution were set in a closed container, and acid treatment was performed thereon at 90° C. for 20 hours. Thus, a porous glass was obtained.

### <<Step (4): Drying Step>>

In the state where the glass obtained in Step (3) was immersed in acid, the temperature of the acid solution was decreased to 40° C. After that, the glass was immersed in purified water at 40° C., and washed for 20 minutes while ultrasonic waves of 28 kHz were applied thereto. The glass was then extracted and left at the room temperature for 12 hours. After that, the glass was dried under conditions in Table 3. The rate of change in mass in the drying step is shown in Table 3.

### <<Step (5): Sintering Step>>

The glass dried in Step (4) was held with an alumina setter of 400 mm×400 mm×10 mm, and sintered under conditions (temperature rising time, control temperature, and temperature dropping time) shown in Table 3. Results of inspection about cracking during the sintering are shown in Table 3. Ex. 23 and 24 are inventive examples, and Ex. 25 and 26 are comparative examples in Table 3. On this occasion, a load per unit area on the glass was 4.5 g/cm².

The “cracking during sintering” was evaluated under the following criteria (n=3) in Table 3.

N: no visual cracking/cracks
Y: visual cracking/cracks

TABLE 3

| | | Ex. 23 | Ex. 24 | Ex. 25 | Ex. 26 |
|---|---|---|---|---|---|
| drying | atmosphere | vacuum furnace | drying | drying | ambient air |
| step | | (20 kPa) | furnace | furnace | |
| | temperature | 50° C. | 50° C. | 50° C. | room |
| | | | | | temperature |
| | time | 3 hours | 10 hours | 3 hours | 12 hours |
| rate of change in mass during | | 14 | 10 | 8 | 0 |
| drying (%) | | | | | |
| sintering | temperature rising | 100° C./hr | 100° C./hr | 100° C./hr | 100° C./hr |
| step | rate | | | | |
| | control temperature | 1050° C. | 1050° C. | 1050° C. | 1050° C. |
| | and time | 10 hours | 10 hours | 10 hours | 10 hours |
| | temperature | 100° C./hr | 100° C./hr | 100° C./hr | 100° C./hr |
| | dropping rate | | | | |
| | sintering condition | ambient air | ambient air | ambient air | ambient air |

| | | | | |
|---|---|---|---|---|
| cracking during sintering | N | N | Y | Y |

As shown in Table 3, in each of Ex. 23 and 24 which were inventive examples, porous glass was dried in the drying step so that the amount of moisture was set within the range defined in the invention before the porous glass was sintered in the sintering step. Thus, the glass was sintered with a large area and without cracking so that a high silicate glass substrate could be produced.

On the other hand, in Ex. 25 and 26 which were comparative examples, the amount of moisture in the drying step was out of the range defined in the invention. Thus, cracking occurred during sintering.

### Experiment Example 4

On Ex. 24 in Experiment Example 3, <<Step (5): Sintering Step>> in Experiment Example 3 was performed under sintering conditions shown in Table 4. Results of measurement of OH-group concentration in obtained glass substrates are shown in Table 4. Ex. 27 to 32 were inventive examples.

TABLE 4

| | | Ex. 27 | Ex. 28 | Ex. 29 | Ex. 30 | Ex. 31 | Ex. 32 |
|---|---|---|---|---|---|---|---|
| sintering | temperature rising | 100° C./hr | 100° C./hr | 100° C./hr | 100° C./hr | 100° C./hr | 100° C./hr |
| step | rate and time | 11 hours | 11 hours | 11 hours | 11 hours | 11 hours | 11 hours |
| | control temperature | 1100° C. | 1100° C. | 1100° C. | 1100° C. | 1100° C. | 1100° C. |
| | and time | 10 hours | 10 hours | 10 hours | 10 hours | 10 hours | 10 hours |
| | temperature | 100° C./hr | 100° C./hr | 100° C./hr | 100° C./hr | 100° C./hr | 100° C./hr |
| | dropping rate | | | | | | |
| | sintering | dew point | dew point | dew point | N₂ | reduced | reduced |
| | atmosphere | 80° C. | 60° C. | 20° C. | | pressure | pressure |
| | | | | | | (20 kPa) | (5 kPa) |

| | | | | | | |
|---|---|---|---|---|---|---|
| OH-group concentration | 1450 | 1300 | 750 | 420 | 560 | 450 |
| (mass ppm) | | | | | | |
| Df at 60 GHz | — | — | 0.00075 | — | — | 0.00065 |

As shown in Table 4, it was found that the OH-group concentration varied in accordance with the sintering conditions.

### Experiment Example 5

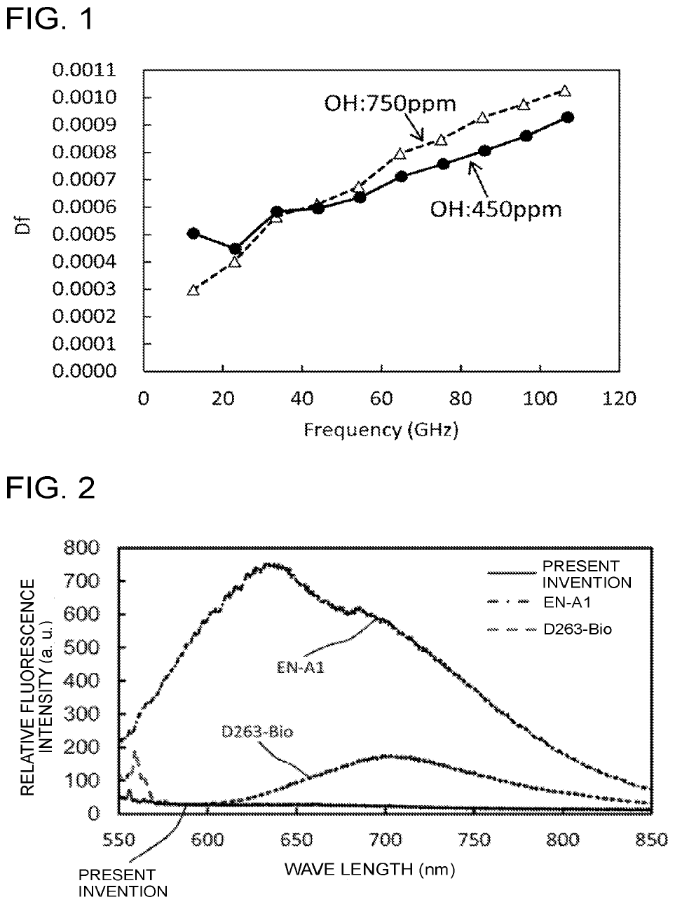

On each of the glass substrates obtained in Experiment Example 4, results of evaluation about a change in Df caused by the OH-group concentration are shown in FIG. 1. As shown in FIG. 1, it was found that the dissipation factor was improved as the OH-group concentration was lower.

### Experiment Example 6

On the glass substrate obtained in Ex. 24 in Experiment Example 3, composition analysis was performed using an ICP emission spectral analysis method. Results are shown in Table 5 as represented by mol % based on oxides.

TABLE 5

| | Ex. 24 | |
|---|---|---|
| | precursor | after sintering |
| composition | mol % | mol % |
| SiO₂ | 66.1 | 96.4 |
| Al₂O₃ | 2.2 | 0.3 |
| B₂O₃ | 24.9 | 3.3 |
| Na₂O | 6.9 | 0.05 |

### Experiment Example 7

On the glass substrate obtained in Ex. 24 in Experiment Example 3, fluorometry was performed under the following conditions. Results thereof are shown in FIG. 2. Apparatus: LabRAM HR Evolution made by HORIBA, Ltd.
excitation wavelength: 532 nm
power: 6 mW@sample
object lens: ×100, NA=0.8
confocal pinhole: 200 μm
grating: 300 gr/mm
measuring time: 1 sec×10 times
measured at position about 15 μm deep from sample surface

As shown in FIG. 2, it was found that in the glass substrate in Ex. 24 which was an inventive example, the relative fluorescence intensity of a fluorescence spectrum from 550 nm to 850 nm was 100 or less, which was lower than that of EN-A1 made by AGC Inc. or D263-bio made by Schott AG.

The invention has been described in detail along its specific forms. However, it is obvious for those in the art that various changes and modifications can be made without departing from the spirit and scope of the invention. Incidentally, the present application was based on a Japanese patent application (Japanese Patent Application No. 2020-097128) filed on Jun. 3, 2020, the entire content of which is applied by reference. In addition, all the content applied herein is incorporated by reference.

1. A method for producing a high silicate glass substrate, comprising:
(1) obtaining a glass precursor comprising, as represented by mol % based on oxides, 60% to 75% of SiO₂, 0% to 15% of Al₂O₃, 15% to 30% of B₂O₃, 0% to 3% of P₂O₅, and 1% to 10% in total of at least one selected from R₂O and R′O, where R is at least one selected from Li, Na and K, and R′ is at least one selected from Mg, Ca, Sr and Ba;
(2) applying first heat treatment to the glass precursor to cause phase separation so as to obtain a phase-separated glass;
(3) applying acid treatment to the phase-separated glass to make the phase-separated glass porous so as to obtain a porous glass;
(4) drying the porous glass so that a rate of change in mass defined in the following Expression 1 reaches 10% to 50%:
rate of change in mass (%)=[(mass before drying−mass after drying)/mass before drying]×100 (Expression 1); and
(5) applying second heat treatment to the porous glass to sinter the porous glass so as to obtain a high silicate glass substrate.

2. The method for producing a high silicate glass substrate according to claim 1, wherein the glass precursor has a base area of 300 cm² or more in (1).

3. The method for producing a high silicate glass substrate according to claim 1, wherein the glass precursor has a rectangular shape with an aspect ratio of 500 to 36000 in (1).

4. The method for producing a high silicate glass substrate according to claim 1, wherein the glass precursor comprises 0.1% or more of P₂O₅ as represented by mol % based on oxides in (1).

5. The method for producing a high silicate glass substrate according to claim 1, further comprising shaping the glass precursor after (1) or after (2).

6. The method for producing a high silicate glass substrate according to claim 5, wherein (1), (2) and the shaping of the glass precursor are performed during continuous production in a refractory furnace.

7. The method for producing a high silicate glass substrate according to claim 1, wherein the porous glass is held at 20° C. or higher and 100° C. or lower and dried in (4).

8. The method for producing a high silicate glass substrate according to claim 1, wherein the porous glass is dried for 1 hour or more in (4).

9. The method for producing a high silicate glass substrate according to claim 1, wherein the acid treatment is performed at a temperature of 40° C. or higher and 100° C. or lower in (3).

10. The method for producing a high silicate glass substrate according to claim 1, wherein the second heat treatment in (5) is performed for sintering under an atmosphere with a dew point of 60° C. or lower.

11. The method for producing a high silicate glass substrate according to claim 1, wherein the second heat treatment in (5) is performed at a temperature rising rate of 100° C./hr or lower.

12. The method for producing a high silicate glass substrate according to claim 1, wherein the glass precursor comprises 1% or less of Cl as represented by mol % in (1).

13. The method for producing a high silicate glass substrate according to claim 1, wherein the high silicate glass substrate is irradiated with a laser beam after (5) so as to form a hole in the high silicate glass substrate.

14. A high silicate glass substrate comprising, as represented by mol % based on oxides, 90% or more and less than 100% of SiO₂, 0% to 1% of Al₂O₃, and 0% to 10% of B₂O₃, having a base area of 300 cm² or more, and having an OH-group concentration of 1200 mass ppm or less.

15. The high silicate glass substrate according to claim 14, wherein a dissipation factor at 60 GHz is 0.001 or less.

16. The high silicate glass substrate according to claim 14, comprising 0% to 3% in total of at least one selected from R₂O and R′O, where R is at least one selected from Li, Na and K, and R′ is at least one selected from Mg, Ca, Sr and Ba.

17. The high silicate glass substrate according to claim 14, having a hole with a diameter of 200 μm or less.

18. A porous glass comprising, as represented by mol % based on oxides, 90% or more and less than 100% of SiO₂, 0% to 1% of Al₂O₃, and 0% to 10% of B₂O₃, having a base area of 300 cm² or more, having a thickness of 3 mm or less, and having a median value of a pore size distribution at 150 nm or less.
